(19) United States
(12) Patent Application Publication
(10) Pub. No.: US 2026/0255010 A1
(43) Pub. Date: Aug. 27, 2026

(54) SYSTEM AND METHODS FOR OBTAINING REGULATED CROWD-SOURCED FUNDS

(71) Applicant: Founders Studio LLC, Wayne, PA (US)

(72) Inventor: Michael Carter, Wayne, PA (US)

(21) Appl. No.: 19/549,569

(22) Filed: Feb. 25, 2026

Related U.S. Application Data
(60) Provisional application No. 63/763,551, filed on Feb. 26, 2025.

(51) Int. Cl. H04N 21/431; G06Q 40/06; H04N 21/4725

(52) U.S. Cl. CPC H04N 21/4316; G06Q 40/068; H04N 21/4725

(57) ABSTRACT

Provided herein is a system and method for interactive video streaming, wherein the system includes: at least one processor; and a memory, wherein the memory contains instructions configuring the at least one processor to: receive video data; generate a video stream user interface, wherein the video stream user interface includes: a video display element and an overlay element; present, through the video stream user interface, the video display element to a user; present, through the video stream user interface, the overlay element to the user; receive, from the user through the video stream user interface, an interaction with the interactive button of the overlay element; and display an investment portal to the user as a function of receiving the interaction with the interactive button of the overlay element.

### CROSS REFERENCE TO RELATED APPLICATIONS

This application claims the benefit of priority to U.S. Provisional Application No. 63/763,551, filed on February 26, 2025, and entitled “SYSTEM AND METHODS FOR OBTAINING REGULATED CROWD-SOURCED FUNDS,” the entirety of which is incorporated herein by reference.

### FIELD OF THE INVENTION

The present invention is directed generally to user interfaces and software platforms. Particularly, the present invention is directed to a system and method for interactive video streaming and system and methods for obtaining regulated crowd-sourced funds.

### BACKGROUND OF THE INVENTION

Crowdfunding is a method of raising capital for projects, ventures, or causes by soliciting contributions from a large number of people, typically through online platforms. The fundamental idea behind crowdfunding is to harness the collective financial power of many individuals, each contributing small amounts, to reach a larger funding goal. This approach has become increasingly popular in recent years, thanks to the rise of social media and digital platforms that make it easier for people to connect, share ideas, and contribute to initiatives they care about.

Crowdfunding can be broken down into several key models: reward-based, equity-based, donation-based, and debt-based crowdfunding. Each model caters to different types of projects and goals

Reward-based crowdfunding: In this model, individuals contribute money to a project in exchange for a reward, which is often a product or service related to the project. This is the most common type of crowdfunding, particularly for creative endeavors, such as launching a new product, film, or art project. Popular platforms like Kickstarter and Indiegogo primarily operate under this model. Backers typically receive tangible rewards for their contributions, such as early access to a product or exclusive merchandise.

Equity-based crowdfunding: Unlike reward-based crowdfunding, equity-based crowdfunding involves individuals investing money in exchange for shares or equity in the business or project. This model is primarily used by startups or growing businesses looking to raise capital to expand. Investors in equity crowdfunding hope to benefit from the future financial success of the business. Platforms like Crowdcube and Seedrs specialize in this type of crowdfunding.

Donation-based crowdfunding: This model involves individuals contributing to a cause or charity without expecting anything in return. It is commonly used for personal or social causes, such as medical expenses, disaster relief, or nonprofit initiatives. Websites like GoFundMe and JustGiving are popular platforms for donation-based crowdfunding. Donors typically contribute out of goodwill and a desire to help others.

Debt-based crowdfunding (also known as peer-to-peer lending): In debt-based crowdfunding, individuals lend money to businesses or individuals with the expectation that it will be repaid with interest. This model provides an alternative to traditional loans from banks and financial institutions. Platforms like Funding Circle and LendingClub operate under this model, allowing individuals to become lenders and earn interest on their investments.

The rise of crowdfunding has been enabled by online platforms that connect project creators with a global audience. These platforms provide tools for creators to present their ideas, set fundraising goals, and offer rewards or incentives to contributors. Social media also plays a significant role in promoting crowdfunding campaigns, as creators can easily share their projects with their networks, gaining exposure and attracting potential backers.

One of the key advantages of crowdfunding is its ability to democratize access to capital. Traditionally, businesses or individuals seeking funding would rely on investors, banks, or venture capitalists, who typically hold significant power in deciding whether a project would receive funding. Crowdfunding, on the other hand, allows anyone with a good idea to access funding from a broad range of supporters. It also provides a platform for market validation, as backers' willingness to contribute can be a sign of interest and demand for the project or product.

However, crowdfunding also has its challenges. Successful campaigns require strong marketing and communication strategies to stand out in a crowded marketplace. There is also the risk that a campaign may fail to meet its fundraising goal, which could leave creators without the funds they need to complete the project. Additionally, creators may face legal and logistical challenges, especially in reward-based or equity crowdfunding, where backers may have specific expectations or rights.

Crowdfunding has revolutionized the way individuals and businesses raise funds, offering new opportunities for entrepreneurs, creatives, and causes to gather financial support from a large and diverse group of people. It has transformed the traditional funding model by emphasizing the power of community and the potential of small, collective contributions. Despite its challenges, crowdfunding continues to thrive as a viable and exciting avenue for innovation and social change.

Regulation Crowdfunding (RegCF) is a framework established by the U.S. Securities and Exchange Commission (SEC) that allows eligible companies—typically startups and small businesses—to raise capital by offering securities to a broad base of investors through online crowdfunding platforms. Introduced under the Jumpstart Our Business Startups (JOBS) Act of 2012 and refined in subsequent years, RegCF democratizes the fundraising process by enabling both accredited and non-accredited investors to participate, thereby expanding the pool of available capital beyond traditional sources such as venture capital or bank loans.

Under RegCF, companies can raise up to $5 million within a 12-month period. This limit is designed to balance the need for businesses to access capital with the protection of investors, ensuring that individual investors are not exposed to undue financial risk. To participate in a RegCF offering, companies must use an SEC-registered intermediary, typically a crowdfunding portal or broker-dealer, which plays a critical role in facilitating the process and ensuring compliance with regulatory requirements.

One of the cornerstones of RegCF is the emphasis on transparency. Companies are required to file detailed disclosures with the SEC before launching their crowdfunding campaigns. These disclosures include comprehensive information about the company’s business model, financial condition, management team, and the specific terms of the offering. Additionally, companies must provide periodic updates to investors, ensuring that those who contribute capital are kept informed about the company’s progress and any significant developments. This ongoing disclosure regime is essential for building trust and helping investors make informed decisions in a market that, by nature, involves higher risks.

Investor protection is another critical aspect of RegCF. Recognizing that many participants may be new to investing, the regulation imposes investment limits on non-accredited investors based on their annual income or net worth. These limits are designed to prevent individuals from investing more than they can afford to lose. Accredited investors, by contrast, typically face fewer restrictions due to their higher level of financial sophistication and access to resources. This tiered approach helps to safeguard less experienced investors while still allowing them the opportunity to participate in potentially high-growth ventures.

RegCF has played a transformative role in the capital-raising landscape by providing startups and emerging businesses with access to a wider array of funding sources. This inclusivity has not only spurred innovation by giving more companies the resources needed to grow but has also allowed everyday investors to partake in early-stage ventures that were once the exclusive domain of wealthy individuals and institutional investors. However, it is important for potential investors to approach these opportunities with caution. Investments in early-stage companies inherently carry risks, including the possibility of complete loss of capital, and thus require thorough due diligence and a clear understanding of the business proposition.

In summary, Regulation Crowdfunding represents a significant evolution in securities regulation. By opening the doors of investment to a broader segment of the public, it fosters innovation, diversifies capital sources, and brings greater transparency and investor protection to the crowdfunding space. While offering exciting opportunities for both companies and investors, RegCF also underscores the importance of careful risk management and informed decision-making in the dynamic world of early-stage investing.

### SUMMARY

In some aspects, the techniques described herein relate to a system for interactive video streaming, wherein the system includes: at least one processor; and a memory, wherein the memory contains instructions configuring the at least one processor to: receive video data; generate a video stream user interface, wherein the video stream user interface includes: a video display element, wherein the video display element is configured to display the video data; and an overlay element, wherein: the overlay element is configured to be displayed over the video display element; and the overlay element includes an interactive button; present, through the video stream user interface, the video display element to a user; present, through the video stream user interface, the overlay element to the user; receive, from the user through the video stream user interface, an interaction with the interactive button of the overlay element; and display an investment portal to the user as a function of receiving the interaction with the interactive button of the overlay element.

In some aspects, the techniques described herein relate to a method for interactive video streaming, wherein the method includes: receiving, using at least one processor, video data; generating, using the at least one processor, a video stream user interface, wherein the video stream user interface includes: a video display element, wherein the video display element is configured to display the video data; and an overlay element, wherein: the overlay element is configured to be displayed over the video display element; and the overlay element includes an interactive button; presenting, using the at least one processor and through the video stream user interface, the video display element to a user; presenting, using the at least one processor and through the video stream user interface, the overlay element to the user; receiving, using the at least one processor and from the user through the video stream user interface, an interaction with the interactive button of the overlay element; and displaying, using the at least one processor, an investment portal to the user as a function of receiving the interaction with the interactive button of the overlay element.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 shows an exemplary video stream user interface;

FIG. 2 shows an exemplary flow diagram of steps to invest;

FIG. 3 shows an exemplary embodiment of a method for obtaining regulated crowd-sourced funds;

FIG. 4 shows an exemplary embodiment of a system for obtaining regulated crowd-sourced funds;

FIG. 5. shows an exemplary data related to a system for obtaining regulated crowd-sourced funds;

FIG. 6 shows an exemplary user interface;

FIG. 7 shows an exemplary method for obtaining regulated crowd-sourced funds; and

FIG. 8 shows an exemplary embodiment of a computing device in the exemplary form of a computer system.

### DETAILED DESCRIPTION

### Definitions

As used herein, each of the following terms has the meaning associated with it in this section. Unless defined otherwise, all technical and scientific terms used herein generally have the same meaning as commonly understood by one of ordinary skill in the art to which this disclosure belongs. Generally, the nomenclature used herein are those well-known and commonly employed in the art. It should be understood that the order of steps or order for performing certain actions is immaterial, so long as the present teachings remain operable. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the application, where an element or component is said to be included in and/or selected from a list of recited elements or components, it should be understood that the element or component can be any one of the recited elements or components and can be selected from a group consisting of two or more of the recited elements or components.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used herein, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

As used herein, the term “ratio” refers to a relationship between two numbers (e.g., scores, summations, and the like). Although, ratios can be expressed in a particular order (e.g., a to b or a:b), one of ordinary skill in the art will recognize that the underlying relationship between the numbers can be expressed in any order without losing the significance of the underlying relationship, although observation and correlation of trends based on the ration may need to be reversed. For example, if the values of a over time are (4, 10) and the values of b over time are (2, 4), the ratio a:b will equal (2, 2.5), while the ratio b:a will be (0.5, 0.4). Although the values of a and b are the same in both ratios, the ratios a:b and b:a are inverse and increase and decrease, respectively, over the time period.

### Detailed Description

Provided herein is a method of obtaining regulated crowd-sourced funds through a streaming platform that includes requesting funding with interacting with an ‘invest now’ button on the streaming platform where the user can pay to invest.

Generally, requesting funding through a platform may be any suitable type of request known in the art that facilitates the service according to the present disclosure. In some embodiments, the request begins with clicking an invest now button. The ‘invest now’ button can be clicked directly through the screen using a pointing device that correlates with the electronic device in use.

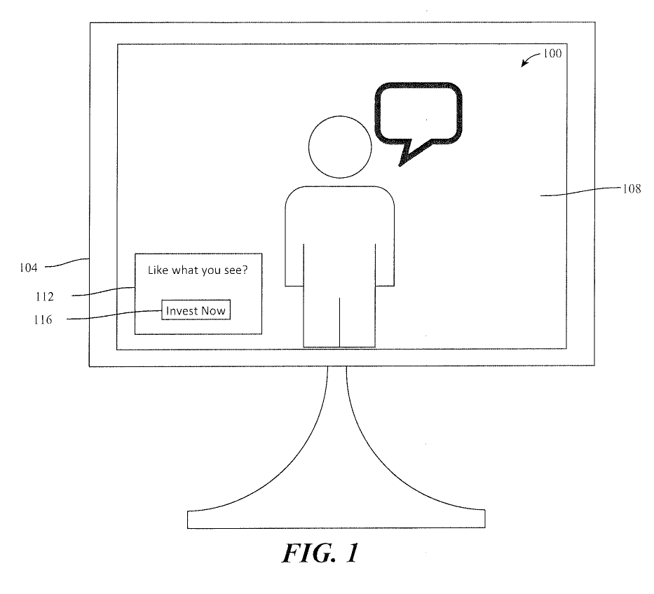

Referring now to FIG. 1, an exemplary embodiment of a video stream user interface 100 is shown. Video stream user interface 100 may interface with a system for interactive video streaming is illustrated. System may include circuitry such as without limitation a processor communicatively connected to a memory; for instance, circuitry may include and/or be included in a computing device. As used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

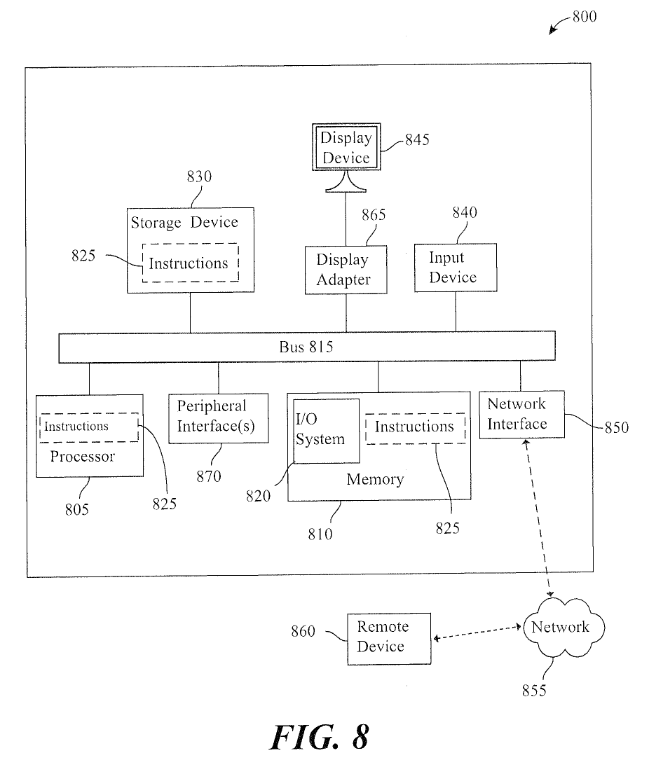

With continued reference to FIG. 1, computing device may be designed and/or configured to perform any method, method step, or sequence of method steps in any embodiment described in this disclosure, in any order and with any degree of repetition. For instance, computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. computing device may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing. Computing device may be further described with respect to computing device 800 in FIG. 8

With continued reference to FIG. 1, computing device may include at least one processor. computing device may also include a memory. The memory comprises instructions configuring the at least one processor to perform one or more actions as described throughout this disclosure.

With continued reference to FIG. 1, system may be configured to receive video data. Video data may include an investor pitch video, investment pitch video, entrepreneur pitch video, or the like. Receiving video data may include receiving embedded video information. Therefore, it is possible that receiving video data may not include receiving the literal data for a video, but instead the information required to embed said video into a website or user interface.

With continued reference to FIG. 1, in some embodiments, video data may include video data that is hosted on a streaming platform. As non-limiting examples, generally, different streaming platforms may be any suitable streaming platforms known in the art that facilitates the service according to the present disclosure. In some embodiments, the streaming platform is selected from the group consisting of Vimeo, YouTube, ads via social media, and combinations thereof.

With continued reference to FIG. 1, video data may include a steamed event. In some embodiments, the event being streamed is selected from the group consisting of live, pre-recorded, on demand and combinations thereof.

With continued reference to FIG. 1, system may be configured to generate video stream user interface 100. In some embodiments, video stream user interface 100 may be presented to a user through a display device 104. Display device 104 may include any suitable display known in the art, including, but not limited to, LCD, OLED, LED, Plasma, CRT, smartphone, laptop, monitor, tablet, ereader, eink, or the like.

With continued reference to FIG. 1, video stream user interface 100 may include a video display element 108. Video display element 108 is a portion of video stream user interface 100 that is configured to display a video, such as the video data. Video display element 108 may include an embedded video. As a non-limiting example, this may include, an embedded video from a steaming platform.

With continued reference to FIG. 1, video stream user interface 100 may include an overlay element 112. Overlay element 112 may be displayed, in some embodiments, over video display element 108. In some embodiments, overlay element 112 may be displayed separate from video display element 108. Overlay element 112 may be configured to present contextual information regarding video data to the user. Overlay element 112 may be configured to prompt the user for a response or input.

With continued reference to FIG. 1, overlay element 112 may include an interactive button 116. Interactive button 116 may include a prompt to the user, such as “invest now.” Some embodiments of interactive button 116 may be referred to as an “invest now button.” In some embodiments, the ‘invest now’ button is shown throughout the streamed event, where the opportunity to click the button arises when an entrepreneur presents. In some embodiments, interactive button 116 may include an investment button. An investment button is a button that a user may click on to make an investment related to the content of video data.

With continued reference to FIG. 1, in some embodiments, system may be configured to present, through the video stream user interface 100, the video display element 108 to a user. This may occur using display device 104. In some embodiments, system may be configured to present through the video stream user interface 100, the overlay element 112 to the user. In some embodiments, this may include displaying 116. In some embodiments, this may include using display device 104.

With continued reference to FIG. 1, presenting, through the video stream user interface 100, the overlay element 112 to the user comprises displaying the overlay element 112 with the interactive button 116 to the user after a set temporal period. For example, this may be a set temporal period after the beginning of a video. This may include presenting the overlay element 112 to a user after a temporal period has elapsed since the beginning of the video. Temporal period may include 5 seconds, 10 seconds, 30 seconds, 1 minute, 5 minutes, or 10 minutes. Temporal period may be 5 seconds to 10 minutes. Temporal period may be 5%, 10%, 15%, 20%, 25%, 50%, 60%, 70%, 75% or a 100% of the runtime of the video. Temporal period may be 5-75% of the runtime of the video.

With continued reference to FIG. 1, presenting, through the video stream user interface 100, the overlay element 112 to the user comprises periodically displaying the overlay element with the interactive button to the user. For example, system may be configured to display overlay element 112 every 1 minute, 5 minutes, 10 minutes or 15 minutes. . For example, system may be configured to display overlay element 112 every 1-15 minutes. In some embodiments, this timer may begin running when a user dismisses or otherwise minimizes or closes overlay element 112. In some embodiments, resenting, through the video stream user interface 100, the overlay element 112 to the user comprises displaying the overlay element with the interactive button to the user for a full duration of the investment pitch video. In some embodiments, the ‘invest now’ button is shown throughout the streamed event, where the opportunity to click the button arises when an entrepreneur presents.

With continued reference to FIG. 1, system may be configured to receive, from the user through the video stream user interface 100, an interaction with the interactive button 116 of the overlay element 112. As non-limiting examples, user may click on or touch interactive button 116 to interact with it. In some embodiments, interactive button 116 may be associated with an event handler which may watch for a user interaction with interactive button 116 and direct the user to the investment portal or registration portal as needed.

With continued reference to FIG. 1, in some embodiments, system may be configured to display an investment portal to the user as a function of receiving the interaction with the interactive button 116 of the overlay element 112.

With continued reference to FIG. 1, generally, an investor can begin to invest after completing certain steps. In some embodiments, after clicking the ‘invest now’ button, the user is redirected to the NCC to create an account. Once an account is made, the investor can then begin investing in entrepreneurs of choice (e.g., using the investment portal). The account gives access to shares and provides the user with yearly statements reporting directly to the company.

With continued reference to FIG. 1, displaying the investment portal to the user as a function of receiving the interaction with the interactive button 116 of the overlay element 112 comprises checking a registration status of the user. For example, this may include whether the user has created an account. This may include looking up a user in a database or lookup table. In some embodiments, displaying the investment portal to the user as a function of receiving the interaction with the interactive button 116 of the overlay element 112 comprises redirecting the user to a registration portal as a function of the registration status of the user being negative. Registration portal may include a page where a user may input information to create a user account and/or register with the service. In some embodiments, displaying the investment portal to the user as a function of receiving the interaction with the interactive button 116 of the overlay element 112 comprises displaying the investment portal as a function of the registration status of the user being positive. In some embodiments, after the account with NCC is created, the user can then select the amount in which the user will invest in for the selected entrepreneur.

With continued reference to FIG. 1, in some embodiments, investment portal may be configured to interface with a payment processor to receive a payment. Generally, the form of payment to use when investing may be any suitable form of payment known the art that facilitates the service according to the present disclosure. In some embodiments, the payment processor is selected from the group consisting of PayPal, credit card, paid platform and combinations thereof. In some embodiments, investment portal may be configured to associate the payment with an identifier associated with the video data. Identifier associated with the video data may include, as a non-limiting example, an entrepreneur ID or user ID associated with the entrepreneur or creator of video data or the service pitched in video data.

Generally, different type of investors may be any suitable type known in the art that facilitates the service according to the present disclosure. In some embodiments, there are different categories for investors. One category is for qualified investors. Qualified investors have the opportunity to give money to invest in the selected entrepreneurs. This type of investor does need to report their investments. In some embodiments, the investor becomes qualified after investing a certain amount of money.

In some embodiments, a different category for investors are unqualified investors. Unqualified investors have the opportunity to give money to invest in the selected entrepreneurs, like qualified investors. However, unqualified investors must report their spending and are labeled unqualified when a certain amount of spending is not reached.

In some embodiments, investors include anyone who clicks on the provided ‘invest now’ button and follows the steps that are introduced after clicking on the button.

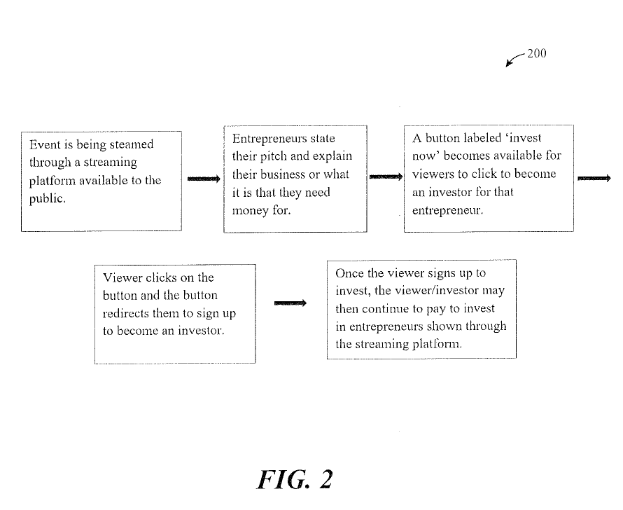

Referring now to FIG. 2, an exemplary flow diagram of steps to invest 200 is shown. In the flow diagram, the overview of viewers becoming an investor through the service is shown. Different steps are taken from once the event is being watched to when the viewer is confirmed as an investor. This, and FIG. 2, is merely an example, which should be viewed as being illustrative and should not be construed to narrow the scope of the present disclosure or limit the scope to any particular embodiments.

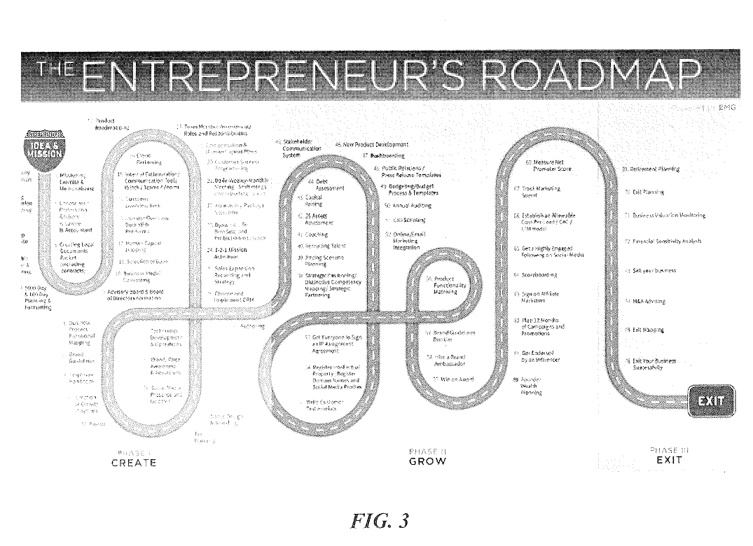

Referring now to FIG. 3, method for entrepreneurship is shown. Method may include an online, AI-enabled service for entrepreneurs that defines the 77 steps needed to complete and then connections the entrepreneur to the service provider or resource to help them complete the step. The invention may include the online/digital design of the Entrepreneurs Roadmap and the engagement by the AI Chatbot for the purpose of helping the entrepreneur complete their roadmap tasks.

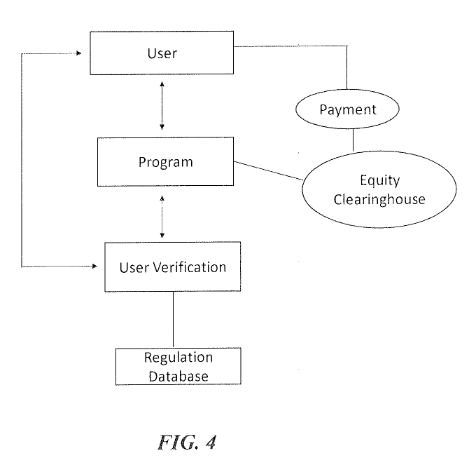

Referring to FIG. 4 an exemplary embodiment of a system for obtaining regulated crowd-sourced funds is shown. System may include, as non-limiting examples, a user, a program, user verification, a regulation database, a payment, and/or an entity clearing house. In some embodiments, chatbot and/or LLM as described above may be configured to query regulation database either to generate output or as a part of RAG.

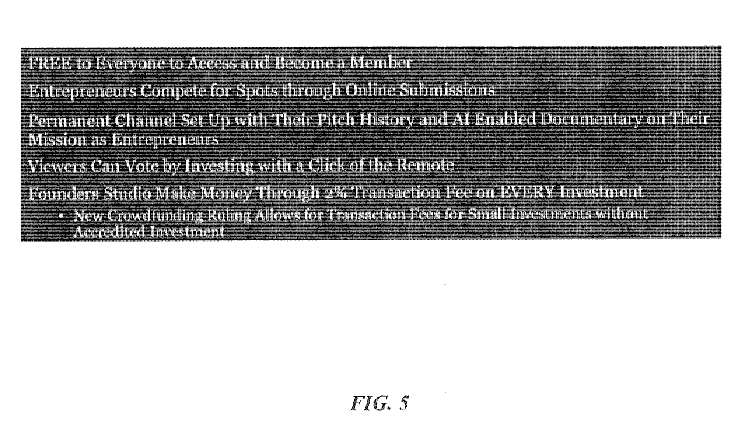

Referring to FIG. 5, it shows exemplary data related to a system for obtaining regulated crowd-sourced funds.

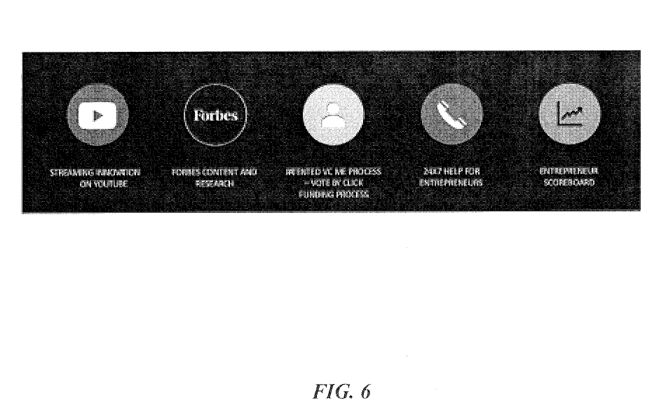

Referring to FIG. 6, it shows an exemplary user interface. User interface may include, as non-limiting examples, a link to YOUTUBE or other video sharing site, a like to a news site (e.g., FORBES), a like to a vote by click funding process, a like to a help line or help chat, and/or a link to an entrepreneur scoreboard.

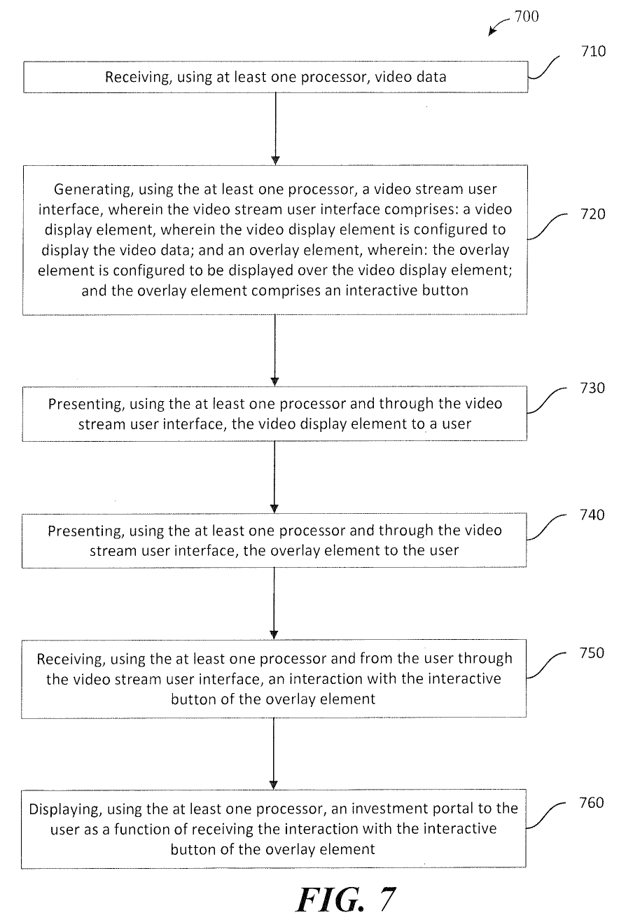

Referring now to FIG. 7, an exemplary method 700 for obtaining regulated crowd-sourced funds is shown. Exemplary method 700 may include a step 710 of receiving, using at least one processor, video data. This may be performed, without limitation, as described with reference to any of FIGS. 1-6.

Referring now to FIG. 7, exemplary method 700 may include a step 720 of generating, using the at least one processor, a video stream user interface, wherein the video stream user interface includes: a video display element, wherein the video display element is configured to display the video data; and an overlay element, wherein: the overlay element is configured to be displayed over the video display element; and the overlay element includes an interactive button. This may be performed, without limitation, as described with reference to any of FIGS. 1-6.

Referring to FIG. 7, exemplary method 700 may include a step 730 of presenting, using the at least one processor and through the video stream user interface, the video display element to a user. This may be performed, without limitation, as described with reference to any of FIGS. 1-6.

Referring to FIG. 7, exemplary method 700 may include a step 740 of presenting, using the at least one processor and through the video stream user interface, the overlay element to the user. This may be performed, without limitation, as described with reference to any of FIGS. 1-6.

Referring now to FIG. 7, method 700 may include a step 750 of receiving, using the at least one processor and from the user through the video stream user interface, an interaction with the interactive button of the overlay element. This may be performed, without limitation, as described with reference to any of FIGS. 1-6.

Referring now to FIG. 7, exemplary method 700 may include a step 760 of displaying, using the at least one processor, an investment portal to the user as a function of receiving the interaction with the interactive button of the overlay element. This may be performed, without limitation, as described with reference to any of FIGS. 1-6.

In some aspects, the techniques described herein relate to a method, wherein the video data includes an investment pitch video.

In some aspects, the techniques described herein relate to a method, wherein the interactive button includes an investment button.

In some aspects, the techniques described herein relate to a method, wherein presenting, through the video stream user interface, the overlay element to the user includes displaying the overlay element with the interactive button to the user after a set temporal period.

In some aspects, the techniques described herein relate to a method, wherein presenting, through the video stream user interface, the overlay element with the interactive button to the user includes periodically displaying the overlay element with the interactive button to the user.

In some aspects, the techniques described herein relate to a method, wherein presenting, through the video stream user interface, the overlay element with the interactive button to the user includes displaying the overlay element with the interactive button to the user for a full duration of the investment pitch video.

In some aspects, the techniques described herein relate to a method, wherein displaying the investment portal to the user as a function of receiving the interaction with the interactive button of the overlay element includes: checking a registration status of the user; redirecting the user to a registration portal as a function of the registration status of the user being negative; and displaying the investment portal as a function of the registration status of the user being positive.

In some aspects, the techniques described herein relate to a method, wherein the investment portal is configured to: interface with a payment processor to receive a payment; and associate the payment with an identifier associated with the video data.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 8 shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 805 and a memory 810 that communicate with each other, and with other components, via a bus 815. Bus 815 may include any of several types of bus structures including, but not limited to, a memory bus, a memory controller, a peripheral bus, a local bus, and any combinations thereof, using any of a variety of bus architectures.

Processor 805 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 805 may be organized according to Von Neumann and/or Harvard architecture as a non-limiting example. Processor 805 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo’s algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 810 may include various components (e.g., machine-readable media) including, but not limited to, a random-access memory component, a read only component, and any combinations thereof. In one example, a basic input/output system 820 (BIOS), including basic routines that help to transfer information between elements within computer system 800, such as during start-up, may be stored in memory 810. Memory 810 may also include (e.g., stored on one or more machine-readable media) instructions (e.g., software) 825 embodying any one or more of the aspects and/or methodologies of the present disclosure. In another example, memory 810 may further include any number of program modules including, but not limited to, an operating system, one or more application programs, other program modules, program data, and any combinations thereof. Memory 810 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 800 may also include a storage device 830. Examples of a storage device (e.g., storage device 830) include, but are not limited to, a hard disk drive, a magnetic disk drive, an optical disc drive in combination with an optical medium, a solid-state memory device, and any combinations thereof. Storage device 830 may be connected to bus 815 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 830 (or one or more components thereof) may be removably interfaced with computer system 800 (e.g., via an external port connector (not shown)). Particularly, storage device 830 and an associated machine-readable medium may provide nonvolatile and/or volatile storage of machine-readable instructions, data structures, program modules, and/or other data for computer system 800. In some embodiments, storage device 830 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software (e.g., instructions 825) may reside, completely or partially, within machine-readable medium . In another example, software may reside, completely or partially, within processor 805.

Computer system 800 may also include an input device 840. In one example, a user of computer system 800 may enter commands and/or other information into computer system 800 via input device 840. Examples of an input device 840 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 840 may be interfaced to bus 815 via any of a variety of interfaces (not shown) including, but not limited to, a serial interface, a parallel interface, a game port, a USB interface, a FIREWIRE interface, a direct interface to bus 815, and any combinations thereof. Input device 840 may include a touch screen interface that may be a part of or separate from display 845, discussed further below. Input device 840 may be utilized as a user selection device for selecting one or more graphical representations in a graphical interface as described above.

A user may also input commands and/or other information to computer system 800 via storage device 830 (e.g., a removable disk drive, a flash drive, etc.) and/or network interface device 850. A network interface device, such as network interface device 850, may be utilized for connecting computer system 800 to one or more of a variety of networks, such as network 855, and one or more remote devices 860 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data neitwork associated with a telephone/voice provider (e.g., a mobile communications provider data and/or voice network), a direct connection between two computing devices, and any combinations thereof. A network, such as network 855, may employ a wired and/or a wireless mode of communication. In general, any network topology may be used. Information (e.g., data, software, etc.) may be communicated to and/or from computer system 800 via network interface device 850.

Computer system 800 may further include a video display adapter 865 for communicating a displayable image to a display device, such as display 845. Examples of a display device include, but are not limited to, a liquid crystal display (LCD), a cathode ray tube (CRT), a plasma display, a light emitting diode (LED) display, and any combinations thereof. Display adapter 865 and display 845 may be utilized in combination with processor 805 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 815 via a peripheral interface 870. Examples of a peripheral interface include, but are not limited to, a serial port, a USB connection, a FIREWIRE connection, a parallel connection, and any combinations thereof.

Further referring to FIG. 8, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 8, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 8, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 800, processor 805, and memory 810 may be virtualized; that is, a virtual machine and/or container may interact directly with such computing system 800, processor 805, and/or memory 810, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 805 comprises a plurality of processors and/or processor cores, virtualization may, in some cases, simulate or emulate a single (virtual) processor whose functions are allocated to one or more of the plurality of processors and/or processor cores. In this case, while processor 805 may be said to be virtualized, the processor 805, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, as discussed above, it should be understood that the particular systems and methods used to implement the disclosure may be modified without changing the spirit of the disclosure, and as such the various art-recognized alternatives are within the scope of the present application.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

What is claimed is:

1. A system for interactive video streaming, wherein the system comprises:
at least one processor; and
a memory, wherein the memory contains instructions configuring the at least one processor to:
receive video data;
generate a video stream user interface, wherein the video stream user interface comprises:
a video display element, wherein the video display element is configured to display the video data; and
an overlay element, wherein:
the overlay element is configured to be displayed over the video display element; and
the overlay element comprises an interactive button;
present, through the video stream user interface, the video display element to a user;
present, through the video stream user interface, the overlay element to the user;
receive, from the user through the video stream user interface, an interaction with the interactive button of the overlay element; and
display an investment portal to the user as a function of receiving the interaction with the interactive button of the overlay element.

2. The system of claim 1, wherein the video data comprises an investment pitch video.

3. The system of claim 1, wherein the interactive button comprises an investment button.

4. The system of claim 1, wherein presenting, through the video stream user interface, the overlay element to the user comprises displaying the overlay element with the interactive button to the user after a set temporal period.

5. The system of claim 4, wherein presenting, through the video stream user interface, the overlay element with the interactive button to the user comprises periodically displaying the overlay element with the interactive button to the user.

6. The system of claim 2, wherein presenting, through the video stream user interface, the overlay element with the interactive button to the user comprises displaying the overlay element with the interactive button to the user for a full duration of the investment pitch video.

7. The system of claim 1, wherein displaying the investment portal to the user as a function of receiving the interaction with the interactive button of the overlay element comprises:
checking a registration status of the user;
redirecting the user to a registration portal as a function of the registration status of the user being negative; and
displaying the investment portal as a function of the registration status of the user being positive.

8. The system of claim 7, wherein the investment portal is configured to:
interface with a payment processor to receive a payment; and
associate the payment with an identifier associated with the video data.

9. A method for interactive video streaming, wherein the method comprises:
receiving, using at least one processor, video data;
generating, using the at least one processor, a video stream user interface, wherein the video stream user interface comprises:
a video display element, wherein the video display element is configured to display the video data; and
an overlay element, wherein:
the overlay element is configured to be displayed over the video display element; and
the overlay element comprises an interactive button;
presenting, using the at least one processor and through the video stream user interface, the video display element to a user;
presenting, using the at least one processor and through the video stream user interface, the overlay element to the user;
receiving, using the at least one processor and from the user through the video stream user interface, an interaction with the interactive button of the overlay element; and
displaying, using the at least one processor, an investment portal to the user as a function of receiving the interaction with the interactive button of the overlay element.

10. The method of claim 9, wherein the video data comprises an investment pitch video.

11. The method of claim 9, wherein the interactive button comprises an investment button.

12. The method of claim 9, wherein presenting, through the video stream user interface, the overlay element to the user comprises displaying the overlay element with the interactive button to the user after a set temporal period.

13. The method of claim 12, wherein presenting, through the video stream user interface, the overlay element with the interactive button to the user comprises periodically displaying the overlay element with the interactive button to the user.

14. The method of claim 10, wherein presenting, through the video stream user interface, the overlay element with the interactive button to the user comprises displaying the overlay element with the interactive button to the user for a full duration of the investment pitch video.

15. The method of claim 9, wherein displaying the investment portal to the user as a function of receiving the interaction with the interactive button of the overlay element comprises:
checking a registration status of the user;
redirecting the user to a registration portal as a function of the registration status of the user being negative; and
displaying the investment portal as a function of the registration status of the user being positive.

16. The method of claim 15, wherein the investment portal is configured to:
interface with a payment processor to receive a payment; and
associate the payment with an identifier associated with the video data.
